(19) United States
(12) Patent Application Publication
(10) Pub. No.: US 2012/0073954 A1
(43) Pub. Date: Mar. 29, 2012

(54) RECOVERY OF ACETONITRILE FROM A WASTE STREAM

(76) Inventor: Romas Cesas, Naperville, IL (US)

(21) Appl. No.: 12/891,998

(22) Filed: Sep. 28, 2010

(51) Int. Cl. B01D 3/34

(52) U.S. Cl. 203/70

(57) ABSTRACT

In an acetonitrile recovery process a waste stream containing methanol and acetonitrile is mixed with hexane and distilled to form a condensate having two layers, a top layer of containing hexane and a bottom layer of methanol and acetonitrile, where selective removal of one or both of these layers allows for a column bottoms product containing at 98 wt. % acetonitrile to be recovered.

### FIELD OF INVENTION

The present invention provides a process to recover acetonitrile (ACN) from a byproduct or waste stream comprising ACN and methanol using one or more hexanes in a distillation process. Manipulation of the bottom phase decant allows for the recovery of high purity ACN.

### BACKGROUND

Unique chemical properties, such as polarity, miscibility with water, low boiling point, low acidity and low UV cutoff, make acetonitrile a versatile solvent. Acetonitrile can be used as a reactant in chemical syntheses, in pesticide manufacture, in pharmaceuticals, and as a solvent in the synthesis of pharmaceuticals and intermediates, oligonucleotides, and peptides. High purity acetonitrile is also a key solvent for HPLC analysis, due to its special properties.

There are several types of acetonitrile commonly used in the marketplace: raw acetonitrile, industrial grade acetonitrile, High Performance Liquid Chromatography (HPLC) grade acetonitrile, DNA synthesis grade acetonitrile, and ultra-pure acetonitrile. Industrial grade acetonitrile is typically used in gas chromatography applications and agricultural pesticide manufacturing processes. HPLC grade acetonitrile is a high purity acetonitrile is typically used to purify and measure synthetic molecules and DNA probes. DNA synthesis grade acetonitrile has one of the highest purities of at least 99.9 percent by weight acetonitrile, and is typically used as a washing agent, reaction solvent, and a diluent in the DNA synthesis process. DNA synthesis grade acetonitrile is also used in the manufacture of DNA synthesis chemicals. Finally, the highest purity is Ultra-pure acetonitrile and contains approximately 20 ppm or less of water

Unlike other solvents, such as methanol, commercial acetonitrile is not the result of a direct synthesis, but is a by-product of the industrial-scale production of acrylonitrile. Acrylonitrile is the primary product of the SOHIO process or ammonoxidation, where propylene reacts with ammonia and air or oxygen in the vapor phase, Usually only 2-4% acetonitrile is formed and is purified by distillation. Raw acetonitrile typically contains up to 50 weight percent acetonitrile and up to 50 weight percent water and is derived from a side reaction during the acrylonitrile manufacturing process. This raw acetonitrile is then purified to meet industry quality specifications for use.

Another significant source of ACN can be found in the waste of universities, research labs, DNA synthesis processes, HPLC process waste, and pharmaceutical production facilities. These waste streams, although generally quite pure, typically are disposed of by fuel blending (reclamation) or incineration. A specific waste stream obtained from ISP Fine Chemicals is a mixture of acetonitrile and methanol, having methanol concentrations around 10 wt. %. This particular waste makes recovery of pure acetonitrile difficult because methanol and acetonitrile form an unfavorable azeotrope, with methanol making up about 19 wt. %. Although there are a number of methods that have been developed to purify acetonitrile from waste streams including azeotrope or extractive distillation, for example U.S. Pat. No. 6,508,917, I am unaware of any process to recover acetonitrile from a waste stream containing methanol. My invention solves this problem by using an azeotrope distillation process where hexane is added to the waste stream comprising acetonitrile and methanol. Purities of acetonitrile of greater than 95 wt. % are achieved. These and other advantages will become evident from the following more detailed description of the invention.

### SUMMARY

My invention is directed to a process for the recovery of acetonitrile (ACN) from a waste stream to yield a product having greater than 95 wt. % ACN. The waste stream that my process treats is an ACN stream that contains approximately 10% methanol, however the ACN can be in range from about 7 to 15%, with ACN acetonitrile being the major other constituent. Water may be present but the amount of water present is a non-factor. Unfortunately, the presence of methanol forms an unfavorable azeotrope with ACN (approximately 19 wt. % methanol/81 wt. % ACN). Distilling the waste to such an azeotropic mixture would results in a huge yield loss of acetonitrile. The known solvent properties of both methanol and ACN was used as a starting point for determining a viable distillation process to remove the methanol while keeping ACN losses low. Methanol is an extremely polar solvent and has negligible solubility in hydrocarbons, very similar to the characteristics ACN displays. Even though both the methanol and ACN would phase from the hydrocarbon, it was hypothesized that the methanol concentration would end up being significantly higher than the ACN concentration if an excess of the hydrocarbon was used in the system.

In a preferred aspect of my invention the waste ACN stream containing methanol is mixed with a hydrocarbon, preferably hexane. Hexane is a hydrocarbon with the chemical formula C₆H₁₄. As used herein “hexane” includes any of four other structural isomers with that formula, or to a mixture of them, even though the IUPAC nomenclature for hexane is typically only for the unbranched isomer (n-hexane). Binary azeotropes are known to exist between ACN, methanol, and hexane. This knowledge was used to design the distillation process of my invention. Although no references to a ternary azeotrope were found in the literature, it was expected to exist and was believed to have less dominance than the methanol/hexane azeotrope. And as such, this binary azeotrope will concentrate at the top of the fractionating column where after it condenses; the methanol will phase out and can be removed from the system. The hexane layer can then be refluxed back to the column to remove more methanol from the system.

Although the following description will relate to a batch type distillation operation, one skilled in the art will readily understand that my invention could be performed as a continuous operation. Azeotropic distillation is my preferred method of recovering ACN. Such a distillation process involves separating close boiling compounds or azeotropes from each other by carrying out the distillation in a multi-plate rectification column in the presence of an added liquid. In my invention, the added liquid is hexane, which itself forms an azeotrope with the ACN and methanol. The presence of hexane on each plate of the rectification column alters the relative volatility in a direction to make the separation of methanol greater than would occur without the addition of hexane. Thus, fewer plates to effect the same separation are required or alternatively a much greater degree of separation with the same number of plates is possible. The process conditions for the process include a temperature range from about 45° C. to about 84° C. and atmospheric pressure to about 8 psig. Preferably, the hexane is introduced with the waste feed to a continuous column. 4 to 5 vol-% of hexane should be utilized for a process with a total column and decanter holdup of around 350 gals. The amount would need a proportional adjustment for a larger or smaller system. The hexane, methanol and a small amount of ACN are removed from the process and a purified ACN stream is removed as a column bottoms product. If desired the hexane can be separated from the methanol by conventional phase separation methods and the hexane recycled for use in the process.

In a particular preferred aspect of my invention there is a method for recovering acetonitrile from a waste stream comprising methanol and acetonitrile, where the waste is introduced into a distillation tower. Hexane can be added to the waste before or after the introduction of the waste stream. This creates an admixture that is distilled to produce a bottoms product comprising at least 98 wt. % acetonitrile and a column overhead product comprising two layers. These two layers include a bottom layer that comprises 50 to 65% methanol, 15 to 30% acetonitrile and 5 to 15% hexane, and a top layer comprising 90 to 100% hexane.

These and other embodiments will become more apparent from the detail description of the preferred embodiment contained below.

### BRIEF DESCRIPTION OF THE FIGURES

The accompanying figure schematically illustrates a one possible embodiment for the process according to my invention.

### DETAILED DESCRIPTION

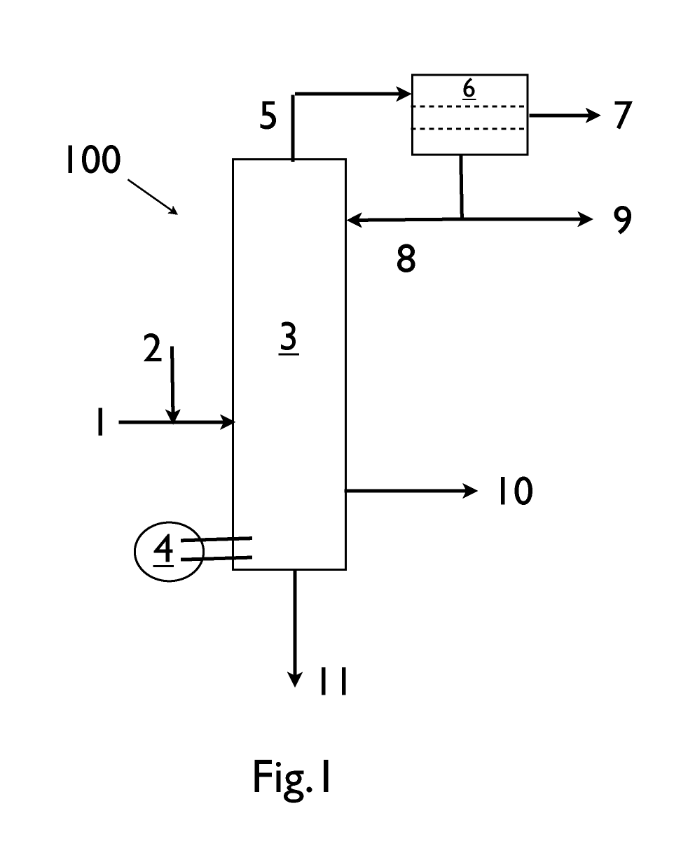

As mentioned, my process can be a batch, semi-continuous or continuous operation. The following embodiment is directed to a continuous operation using a single distillation column. FIG. 1 illustrates an acetonitrile purification system 100 in one embodiment of the present invention. In accordance with the present invention, a waste feedstock 1 containing approximately 89.9 wt. % ACN, 10 wt. % methanol, and 0.1 wt. % other contaminants is mixed with a hexane feed 2 at a volume ratio of in the range from approximately 100 to about 4 to form an admixture containing approximately 5 wt. % hexane. The admixture is then introduced into distillation column 3. It is appreciated that the acetonitrile feedstock may contain more or fewer constituents, provided that it contains methanol in the range of from about 7 wt. % to about 15 wt. %. Preferably, feedstock 1 comprises between zero and 5 percent by weight water, and more preferably between zero and 2 percent by weight water, though this is not imperative these concentrations make it easier to generate very dry ACN product.

Generally, distillation column 3 contains internals such as packing, trays, sieves, bubble caps or similar mechanical configurations which can provide stages of multiple, step wise contact for vapor-liquid streams flowing through the system to approach equilibrium. The number of stages and type of internals used in distillation column 3 will vary depending feedstock composition, feedstock inlet location, reflux ratios, desired column efficiency, etc. As such, the column profile will vary from one application to another. A heat exchanger reboiler 4, located at the bottom of column 3, provides heat to the column. Based on the known binary azeotropic and normal pure component boiling temperatures, essentially all of the acetonitrile/methanol azeotrope and hexane are rectified to produce column 3 outlet vapor stream 5. Upon exiting column 3, vapor 5 is condensed within condenser 6 to produce two layers, a bottom layer containing methanol and ACN and a top layer of primarily hexane. A reflux stream 7 from the top layer is returned to column 3 and slip streams 8 and 9 from the top and bottom layers respectively are used to control the purity of the ACN stream removed in stream 10. Purities of ACN in stream 10 can be at least 98 wt. % and up to 99.97 wt. %.

The high-boiling degradation products are stripped within column 3 and are discarded from the bottoms in stream 11 (or as pot bottoms in a batch operation). The yield of acetonitrile (i.e. process efficiency) is dependent upon the balance of reflux ratio, number of stages within column 3, and the removal of slip streams 8 and/or 9. Reflux stream 7 can be further processed to recover the hexane or recycled back into the process. Preferably the temperature at the top of the column is in the range of from about 115° F. to about 128° F. and the bottom of the column is in the temperature range of from about 170° F. to about 183° F. The pressure of the column is preferably at atmospheric pressure but can range to about 8 psig.

The foregoing description of the specific embodiments will so fully reveal the general nature of the invention that others can, by applying current knowledge, readily modify and/or adapt for various applications such specific embodiments without departing from the generic concept, and therefore such adaptations and modifications are intended to be comprehended within the meaning and range of equivalents of the disclosed embodiments. It is to be understood that the phraseology or terminology herein is for the purpose of description and not of limitation.

The means, materials, and steps for carrying out various disclosed functions may take a variety of alternative forms without departing from the invention. Thus, the expressions “means to . . . ” and “means for . . . ”, or any method step language as may be found in the specification above or the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same function can be used; and it is intended that such expressions be given their broadest interpretation within the terms of the following claims.

1. A method for recovering acetonitrile from a waste stream comprising,
feeding a waste mixture comprising methanol and acetonitrile to a distillation tower;
adding hexane to the waste mixture to create an admixture; and
distilling the admixture to recover a bottoms product comprising at least 98 wt. % acetonitrile;
removing a column overhead product where it is condensed to form two layers comprising a bottom layer comprising methanol and acetonitrile and a top layer comprising hexane.

2. The method of claim 1 where a first portion of the bottom layer is returned to the distillation column and a second portion of the bottom layer is removed from the process.

3. The method of claim 2 where the first and second portions of the bottom layer are varied to control and maintain acetonitrile purity of at least 98 wt. % in the bottoms product.
